(19) United States
(12) Patent Application Publication
(10) Pub. No.: US 2018/0364777 A1
(43) Pub. Date: Dec. 20, 2018

(54) DYNAMIC CONNECTION OF THE ELECTRIC POWER SUPPLY

(71) Applicant: ETIX LABS S.A.R.L., Luxembourg (LU)

(72) Inventors: Charles BEYNEY, Luxembourg (LU); Julien ROUESSARD, Luxembourg (LU); Thomas BLOTTIAUX, Luxembourg (LU)

(21) Appl. No.: 16/063,037

(22) PCT Filed: Dec. 16, 2016
(86) PCT No.: PCT/EP2016/081547

§ 371 Date: Jun. 28, 2018

(30) Foreign Application Priority Data
Dec. 17, 2015 (FR) 1562692

(51) Int. Cl. G06F 1/26; G06F 1/32; H02J 1/14

(52) U.S. Cl. CPC G06F 1/263; H02J 1/14; G06F 1/3206

(57) ABSTRACT

A system for managing electric power supply of plural apparatuses in a facility, in which each of the apparatuses, which consume electric energy, are electrically connected to plural electric power supply sources via at least one distribution device, each of the power supply sources having a predetermined performance curve, and in which the at least one distribution device includes switching elements configured to distribute the electric energy necessary for the operation of the apparatuses, the at least one distribution device includes: a central processing unit for determining a load plan on the basis of at least one subscribed power for each of the apparatuses and a distribution algorithm; and control circuits configured to control the switching elements in real time on the basis of the load plan, in such a way so as to perform dynamic connection switching of the apparatuses to the power supply sources.

### TECHNICAL FIELD AND PRIOR ART

The present invention relates to the field of management of the power supply of apparatuses that consume electricity.

One objective of the present invention is to improve the operating conditions of the apparatuses, which consume electricity, in a facility by optimizing the management of power supply distribution of for each of these apparatuses.

The present invention finds a particularly advantageous application in the field of data processing centers (or datacenters) to improve the energy efficiency of these centers.

It is understood that the present invention has further advantageous applications in other fields such as e.g., power supply management for computer apparatuses of “Smart Cities” for example, to efficiently manage the distribution of energy in office buildings (optimization of load among different sources) or in telecommunications centers.

Throughout the specification that follows data, the terms processing center or datacenter refer to a facility that houses computing apparatuses (mainframes, servers, storage server racks, network equipment and telecommunications, etc.) the purpose of which is to store data (more or less sensitive) owned by third parties, subscribers to said datacenter, in order to ensure in particular the security and integrity of these data or supporting/hosting data processes or applied calculations.

Generally, data processing centers for information security reasons also include an emergency redundant power supply system to prevent loss of data (stored or processed) and so offer to subscribers who use such centers high quality service, and a high level of availability.

Data processing centers consume a lot of electricity.

Note that the activity associated with data processing center “industry” in the past few years has become the 5^{th} the largest consumer of electricity, making up more than 2% of the world consumption of electricity.

Moreover, given the increasing number of data being stored, especially with the arrival of “Cloud Computing” services and the proliferation of being stored (especially with the rise of social and professional networks, etc.), data processing centers' electrical needs should still grow significantly in the coming years.

In Europe, it was estimated in 2008 that datacenters consumed more than 56 TWatts. By 2020, this consumption is estimated to surpass 100 TWatts.

We already know that more than half of this electrical energy is consumed for cooling and air conditioning servers.

In addition to these issues related to temperature, the problems related to energy efficiency and management of the power supply present a growing challenge for players in this field.

A data processing center, which we will call datacenter hereinafter in the description for brevity, should be able to supply electrical power to the various computer apparatuses (including server racks) housed in said datacenters regardless of the circumstances (even in the event of power supply failure or power outage).

This is very important to ensure the safety and integrity of stored data, as well as the availability thereof.

Ensuring the continuous electrical power supply of the computer apparatuses, including server racks and servers, is therefore essential.

There are to date several approaches to supply electrical power to the computer apparatuses of these datacenters.

A first approach to ensure the quality of the distribution of electrical power is to impose a specific electrical wiring for the computer racks on the different power sources.

This ensures redundancy of the sources for each bay.

Such wiring is nevertheless static.

This is indeed determined from a distribution table, also known as “capacity planning”, which is based primarily on the powers initially subscribed to by the subscriber services.

The Applicant submits here that such a table is usually done by hand, which is tedious and often a source of potential errors.

This table may possibly be updated in time on the basis of actual recorded and consumed powers. In this case, this table must be recalculated and rewiring must be done accordingly.

This first approach is very demanding for the operator of the datacenter.

We must further ensure that, when wiring, each power supply is properly balanced in phase relative to each other. It may therefore be necessary to rewire during operation to balance the phases properly on the basis of actual power consumed.

The power supplies must be protected against overloading in the event of failure of one of them.

Since wiring is static in nature, it is difficult to adapt in real time to the energy needs of the server racks.

This is especially true when the need for rewiring arises in theory when a new subscriber subscribes to the datacenter, or when commissioning new server racks.

Note also that an error in the calculation of the distribution table or an error in the wiring can cause complete shutdown of operations.

This approach no longer seems appropriate since the wiring, which is static and is done by hand, requires regular maintenance, and is thus limiting and a source of error (and therefore a security weakness).

Note, moreover, that this approach is inefficient in terms of energy: it cannot guarantee optimum power supply in real time.

Indeed, although after wiring the power balance can be considered to be optimal, it quickly becomes imbalanced as energy needs vary over time depending on the activity and requested data resources.

However, power consumption in datacenters is by definition subject to drift during operation (imbalance), which inevitably requires regular rewiring.

In addition to this balancing problem, the Applicant also submits that the need for redundancy requires the facility to have more power sources.

For example, to provide for a computer room of 1 MWatts at least two power sources which are required each capable of providing for the whole room in case of failure of the other source. Two power sources are therefore required, in this case, that are each capable of providing 1 MWatts.

Here is assumed that 50% of the production capacity of the facility is untapped, which may seem absurd from an economic and financial point of view.

Note also that the electrical redundancy with two power sources is not fully satisfactory; certainly, it ensures that the failure of a source does not affect the operation of the site. However, the failure of the second source inevitably cause complete cessation of operation of servers. Data security is not fully guaranteed.

With static wiring, it is difficult to improve the situation, even with three or four power sources. Indeed, the servers usually have only two inputs and it is not possible to predict to which source you need to connect them to ensure they are always powered after failure of both sources.

To ensure the balance of power, a second approach is to generate single-phase lines using three-phase/single-phase converters.

Such a solution allows for devices that are not line allocation devices but true single-phase inverters which draw energy in a balanced way from the three phases of a three-phase source.

This is however not suitable for a datacenter, since the use of such converters does not have good energy performance.

The Applicant observes here that the energy losses associated with these components result in a major heat dissipation problem, which is not acceptable for being applied in the field of datacenters.

The Applicant further observes that such a solution does not allow to adjust the load between sources.

Finally, another approach is to supply each of the servers in the datacenter with low voltage type DC (e.g., 48 volts).

Technically, this has the advantage of reducing the number of stages of the electric transformation; only one interface of the DC voltage in similar orders of magnitude.

According to this approach, it is no longer necessary to balance the consumption of each server on high voltage AC power sources.

Moreover, it is not necessary to have high voltage and low frequency transformers to ensure redundancy of power sources, simplifying infrastructure.

The Applicant observes, however, that in such an approach at the same power consumption, currents are much stronger, and thus need higher conductor sections.

This approach requires the customer datacenter to be equipped with low voltage servers, which is not feasible in practice.

The Applicant also observes that the count of the power consumption actually consumed is achieved in existing solutions by the presence of meters on each server rack. This represents a significant hardware investment, which also requires skilled labour.

Apparatuses for centralized data reporting are furthermore required in order to install these meters.

In any event, the Applicant submits that, to date, the state of the art has no simple and effective technical solutions to optimize the distribution of the power to the server racks in a datacenter while guaranteeing phase load balancing within each power source.

### OBJECT AND SUMMARY OF THE PRESENT INVENTION

The object of the present invention is to improve the current situation.

One objective of the present invention is to overcome the disadvantages of the prior art mentioned above by providing dynamic switching of the apparatuses (such as, for example, servers or server racks in a datacenter) on the power sources.

The term apparatus here refers a device that requires a power supply to operate.

The proper functioning of such an apparatus is directly related to the quality of the electric power supply.

More particularly, the present invention relates in a first aspect a power management method of a plurality of apparatuses in a facility (e.g., servers or server racks in a data processing center or datacenter).

According to the invention, each of the apparatuses (e.g., servers or server racks in a datacenter), which consume electrical energy, is electrically connected to a plurality of power sources by means of at least one distribution device comprising each of the switching elements forming the interface between the apparatuses and the power sources.

According to the invention, each of the power sources has a yield curve of its own.

According to the invention, the switching elements are controlled in real time by control circuits, such as for example, programmable logic circuits, and are configured to distribute the electrical energy needed to operate the apparatuses (e.g., servers or server racks).

At the beginning of operation, this energy distribution is made according to a nominal allocation. The nominal allocation is determined by said nominal load plan.

Advantageously, the method according to the invention is implemented by computer means and includes the following steps in an operational phase:
determining a load plan by the central unit according to at least one subscribed power to an apparatus and a distribution algorithm taking into consideration the performance curves of each of the sources so as to adjust the nominal allocation of power sources to each of the apparatuses (e.g., servers or server racks) maximizing the performance of said sources, or more precisely by maximizing efficiency;
a dynamic switching of the apparatuses (e.g., servers or server racks) on the power supplies carried out by the switching elements on the basis of said load plan from the central unit to each of the control circuits.

Thus, the present invention, through the combination of these different technical steps which are characteristic of the present invention, enables dynamic wiring that takes into consideration the different power subscribed to for each apparatus.

It is possible for example for a subscriber to a service to change in operation the power subscribed for a rack.

In this case, the load plan will be automatically changed taking into consideration this new subscribed power.

Such dynamic cabling eliminates static wiring used presently. It is no longer necessary to provide for the manual establishment of a new load plan (or “capacity planning”) for each commissioning of new apparatuses or when a new subscriber subscribes to services.

According to optional features of the invention alone or in combination:
the method includes a continuous measurement of the power consumption of each of the apparatuses (e.g., servers or server racks);
the load plan is determined on the basis of the measured consumption;
the switching elements measure by magnetically coupling the power consumption of each of the apparatuses (e.g., servers or server racks) that they respectively supply;
the measured power consumption is time-stamped and then stored in a computer file, known as a log file, and periodically transmitted to the central unit;
the method comprises a continuous monitoring of the status of each power source for detecting the failure of at least one of the power sources;
the load plan is determined according to the source status;
when monitoring of the status of each of the power sources, a power source is considered to be in a failure status when it delivers a voltage outside a range between a lower failure threshold and an upper failure threshold;
preferably, the lower failure threshold and/or the upper failure threshold are configurable voltage values;
the method comprises an initialization phase during which, during a step of subscription, the nominal load plan is determined on the basis of an electric power previously subscribed to by a subscriber, the subscribed electric power being moreover associated with a certain level of service quality;
the process comprises an interruption of the power supply to an apparatus (e.g., a server rack) by said power source associated in the event of detecting abnormal consumption by said apparatus, when for example it is strictly greater than 150% of the subscribed power.

Correspondingly, the object of the present invention relates in a second aspect to a computer program comprising instructions adapted for executing the steps of the method as described above, when said computer program is executed by at least one processor.

Such a computer program may use any programming language and take the form of source code, target code or a code intermediate between source code and target code, such as in a partially compiled form, or in any other desirable form.

Similarly, the object of the present invention relates in a third aspect to a storage medium readable by a computer on which a computer program is recorded comprising instructions for executing the steps of the method as described above.

First, the recording medium can be any entity or device capable of storing the program. For example, the medium may comprise storage means such as a ROM type memory microelectronic circuit, or a magnetic recording medium or a hard disk.

On the other hand, this recording medium can also be a transmissible carrier such as an electrical or optical signal, such a signal can be conveyed via an electrical or optical cable, by classical or terrestrial radio or by self-directed laser beam or other ways. The computer program of the invention may particularly be downloaded over an Internet-type network.

Alternatively, the recording medium may be an integrated circuit in which the computer program is embedded, the integrated circuit being adapted to execute or to be used in executing the process in question.

The object of the present invention relates in a fourth aspect to a power supply management system to a plurality of apparatuses (e.g., such as server racks) in a system (e.g., such as data processing centers or datacenter).

Advantageously, said system comprises computer means configured for the implementation of the method steps as described above.

More particularly, in this system, each apparatus (e.g., server racks) is electrically connected to a plurality of power sources through at least one distribution device.

According to the invention, each source has a yield curve of its own.

According to the invention, each distribution device includes switching elements forming the interface between the apparatuses and the power sources.

These switching elements are preferably configured to distribute the electricity needed to operate the equipment.

At the beginning of operation, this distribution is made according to a predetermined nominal allocation.
Advantageously, the distribution device comprises: a central processing unit configured to determine a load plan on the basis of at least one subscribed power for each device and a predetermined distribution algorithm taking into consideration the performance curves of each source so as to adjust the nominal allocation of power sources to each of the devices (e.g., server racks) maximizing efficiency; and
control circuits configured to control in real time the switching elements so as to achieve dynamic switching of the apparatuses (e.g., server racks) on the power sources according to the load plan from the central unit.

In a particular embodiment, the switching elements comprise:
a semiconductor of the IGBT type (acronym for “Insulated Gate Bipolar Transistor”), and/or
a TRIAC-type electronic component (acronym for “Triode for Alternating Current”). Such a component is equivalent to the parallel connection of two anti-parallel connected thyristors.

Preferably, the distribution device is configured to deliver single-phase respectively, from three-phase and/or four-phase.

Such a system also allows a disjunction system that can be changed hot without interrupting the entire site's power.

The object of the present invention relates in a fifth aspect to a data processing center or the datacenter type facility comprising:
a plurality of power sources;
a plurality of apparatuses notably including server racks; and
a power management system such as that described above.

Preferably, each power source includes an inverter.

Thus, the object of the present invention, through its various functional and structural aspects described above, provides datacenter with real dynamic wiring of the apparatuses on power sources taking into consideration the subscribed powers, the actual energy consumption, and possibly the source statuses.

As applicable to the field of datacenters, the present invention optimizes the energy efficiency of datacenters and ensure the security, integrity and availability of data stored in datacenters.

### BRIEF DESCRIPTION OF THE APPENDED FIGURES

Other characteristics and advantages of the present invention will emerge in the description below with reference to appended FIGS. 1 and 4 which show a non-limiting embodiment in which:

FIG. 1 shows a schematic view of a power management system for datacenter server racks according to an example embodiment of the invention;

FIG. 2 shows a flowchart of the steps of the management method according to an example embodiment of the present invention;

FIG. 3 shows a schematic view of an example casing structure in a switch panel according to an example embodiment;

FIG. 4 shows a schematic view of an example distribution panel according to an example embodiment.

### DETAILED DESCRIPTION OF THE INVENTION

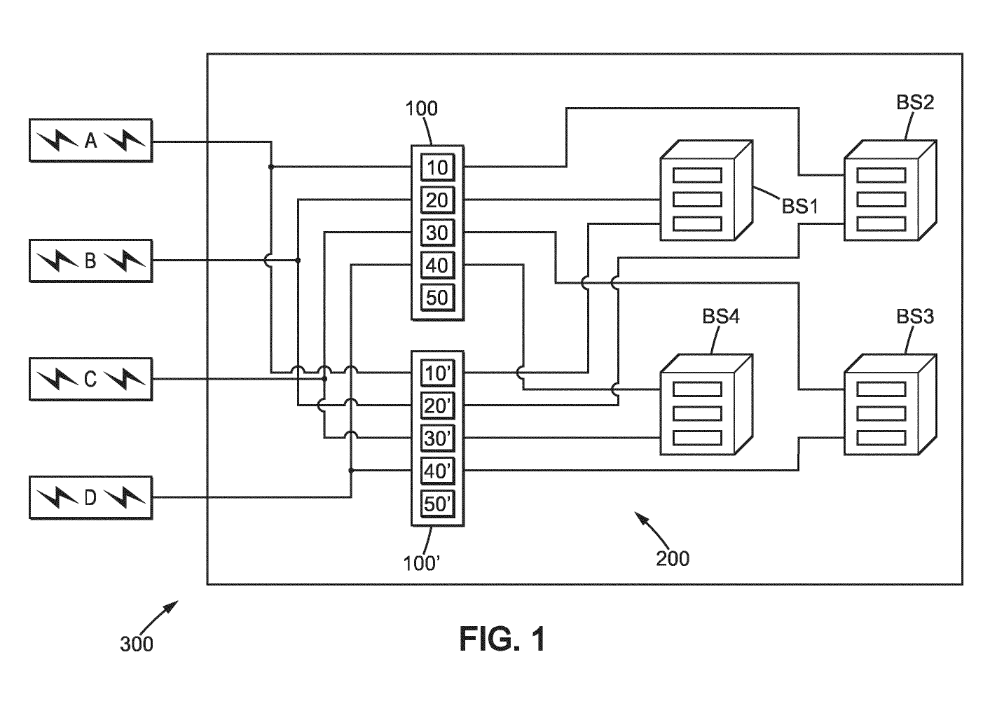

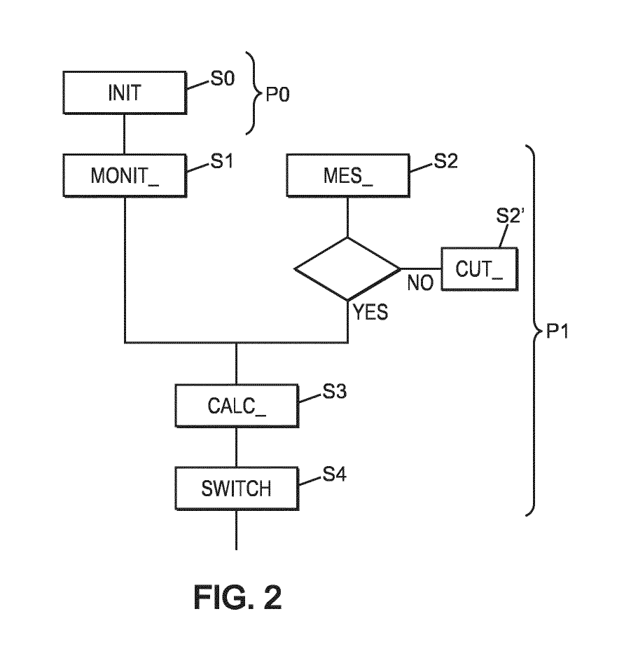

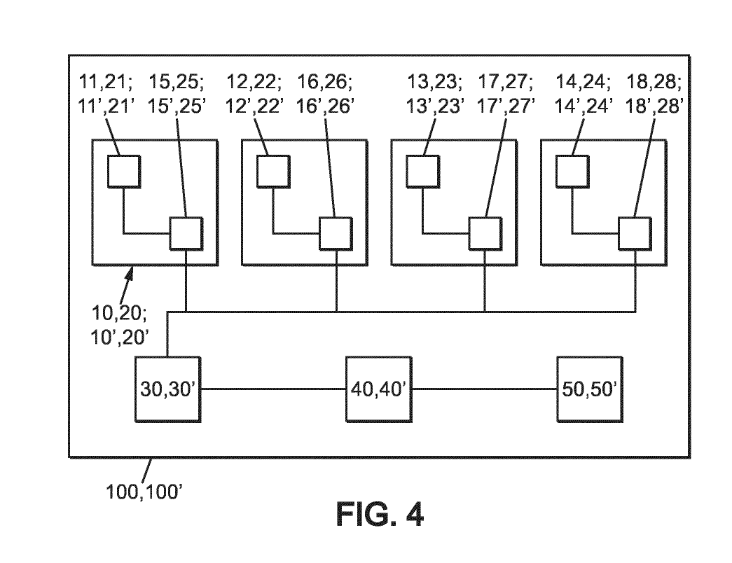

Managing the power supply of a plurality of apparatuses in a facility and the system associated therewith will now be described in what follows with reference jointly to FIGS. 1 to 4.

The example described here relates more particularly to the management of server power or server racks in a datacenter. Of course, it is understood here that this is a particular application among other possible applications.

Designing a wiring capable of choosing at any time what source powers any server rack is an objective of the present invention.

This is possible in the present invention by dynamic cabling of the server racks on the power sources according to the actual consumption of each of them and the power source statuses.

In the example described here, there is a power management system 200 comprising computer and electronic means to efficiently manage the distribution of the power to server racks BS1, BS2, BS3 and BS4 in a datacenter 300.

In the example described herein and illustrated in FIG. 1, server racks BS1, BS2, BS3, and BS4 are electrically connected to power sources A, B, C and D by means of two distribution devices 100 and 100′, in this case switch panels.

Of course, it is understood here that the system 200 can include more than two switch panels.

A person skilled in the art would also understand =that this is a particular example of embodiment and in the framework of the present invention can provide a decentralized architecture without a switch panel; in such a configuration, all racks are served by all sources, and the allocation is done at the foot of the rack.

In this example, the power sources A, B, C and D are inverters each having their own performance curve. Of course, other types of power sources can be considered.

In this example, the panels 100 and 100′ serve as a “Power Switch” and each comprise boxes 10, 20 and 10′, 20′ (called “Switching Units” or SWU).

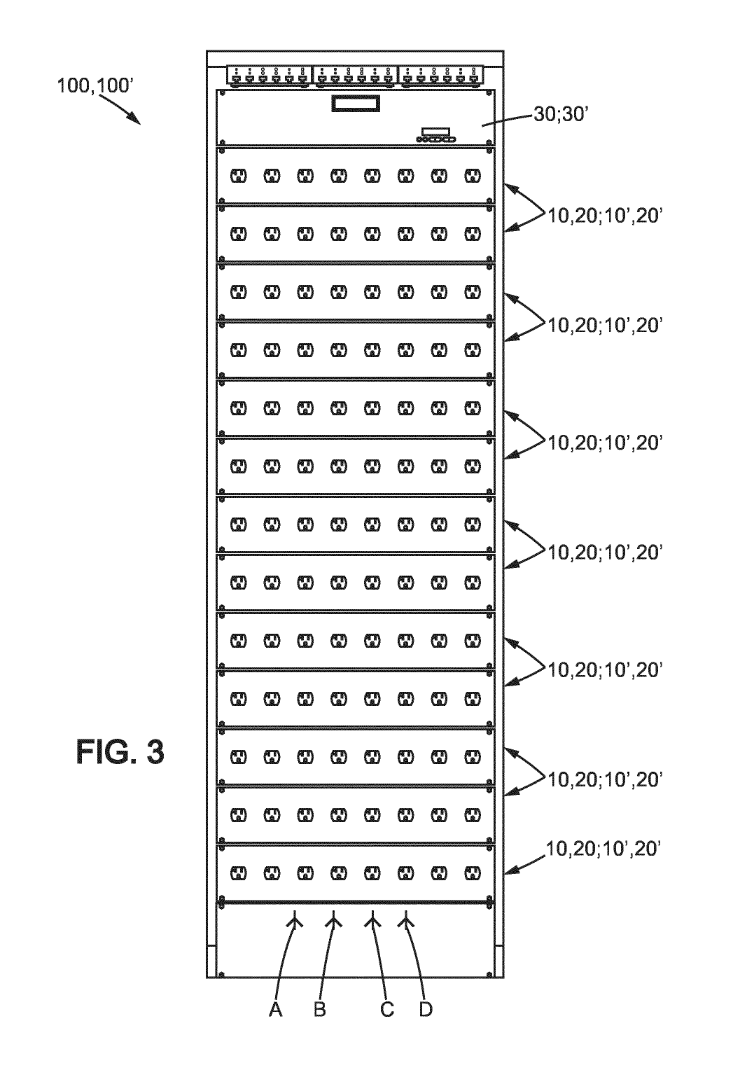

In these boxes, are arranged switching elements respectively (11, 12, 13, 14; 21, 22, 23, 24) and (11′, 12′, 13′, 14′; 21′, 22′, 23′, 24′) which interface between the server racks BS1, BS2, BS3 and BS4 and the power sources A, B, C and D (see FIG. 3).

In this example, these switching elements (11, 12, 13, 14; 21, 22, 23, 24) and (11′, 12′, 13′, 14′; 21′, 22′, 23′, 24′), also called “switching elements” or SWE, are intended to distribute the electrical energy required to operate the server racks BS1, BS2, BS3 and BS4.

These SWE are controlled by control circuits (15, 16, 17, 18; 25, 26, 27, 28) and (15′, 16′, 17′, 18′; 25′, 26′, 27′, 28′), here, for example, programmable logic circuits providing distribution instructions in real time from the power supply defined by a load plan to the SWEs.

At the beginning of operation, called a nominal phase, the switching elements (11, 12, 13, 14; 21, 22, 23, 24) and (11′, 12′, 13′, 14′; 21′, 22′, 23′, 24′) distribute the electrical energy necessary to operate each server rack BS1, BS2, BS3 and BS4 in a nominal load plan; also known as nominal allocation.

This nominal load plan can be determined as follows:

During this phase, a step S0 is envisaged in which the subscriber subscribes to a data storage or application hosting service with a datacenter 300 and selects a quality of service associated with the level of security that said subscriber wants for its data.

This quality of service is directly related to the redundancy of power sources, and thus to an electrical power. Also known as subscribed power.

The Applicant asserts that the present invention is particularly relevant in a datacenter 300 where there is a great deal of “application calculations” and little data storage: in fact, in this case consumption is less consistent.

Moreover, only the calculation servers (farm) will be at a “level 0” (see below).

A server, for example, “Level 3” (or “level 2”) can be considered to remain functional after three failures (high reliability) (or two failures) while a “Level 1” server remains functional after a single failure and is offline after the second failure.

The subscriber therefore has the opportunity to subscribe to an availability level adjusted best to its needs.

Note here that it is possible within the framework of the present invention to provide a minimum operating range with zero failure, i.e. the server is allocated upon the first failure of its source: in this case, also known as “level 0”.

This may seem precarious, but the interaction with the hypervisor virtual machines can organize the machines so that the servers in question are, for example, farm servers or other elements, and that their failure does not cause loss of service but at most a decline in performance.

During this phase, the central units 30 and 30′ of each panel 100 and 100′ thus recover all the powers subscribed to by all subscribers and calculate on the basis of this information a first load plan, known as a nominal plan.

This load plan therefore corresponds to the nominal allocation of power sources A, B, C and D to each of the server racks BS1, BS2, BS3 and BS4.

It is this initial phase P0 that can affect power sources A, B, C and D to different server racks.

Each panel 100 (100′), the central unit 30 (30′) then sends to each output of the boxes 10 and 20 (10′and 20′) the sources of nominal power supply to be allocated and the different failure scenarios associated with power sources.

In this example, the nominal load plan and the different failure scenarios are thus stored in each box 10 and 20 (10′and 20′) on programmable logic circuits 15, 16, 17, 18; 25, 26, 27, 28 (15′, 16′, 17′, 18′; 25′, 26′, 27′, 28′).

These circuits are preferably FPGA circuits and can manage security protocols and allocation of sources in real time.

It is possible for the service subscriber to modify this subscribed power (e.g., remotely); in this case, the load plan is recalculated by the central unit to take into account this change in power.

Observing during operation (in this case PI phase) the actual electricity consumption of the racks and the statuses of the sources in order to dynamically change the load plan is an objective of the present invention.

In the example described herein, for this purpose, each panel 100 and 100′ comprises a measuring module 50 and 50′ which, in a step S2, by magnetic coupling measures the power consumption of each of the server racks BS1, BS2, BS3 and BS4.

Preferably, in the example described here, these are the switching elements which perform this measurement by magnetic coupling.

Alternatively, it is also possible to perform a resistive measurement, for example by “shunt” resistances.

It should be noted here that, for measuring the (power) consumption, it is desirable to also measure the voltage (in the event of the amplitudes from different sources).

This ability to measure currents and voltages makes it possible to provide other electrical indicators such as voltage and effective current, active and reactive power, phase shifts, the harmonic ratio in current and voltage, and finally inrush currents.

Of course, one can imagine other embodiments in which a specific measurement module performs these consumption measurements.

In this example, the measurement function 50 and 50′ is thus directly integrated in the switching elements. This is an example of a possible embodiment.

This power consumption measured continuously throughout the operation is time-stamped and then stored in a computer file, known as a log file, transmitted periodically (e.g., every minute) to the central unit 30.

In this example, the central unit 30 processes, at step S3, all log files received in order to thereby determine a new load plan to adjust the nominal allocation of power sources A, B, C and D on each of the server racks BS1, BS2, BS3 and BS4 so as to drive the switching elements in order to achieve dynamic switching S4 of server racks BS1, BS2, BS3 and BS4 on the power sources A, B, C and D.

In this example more particularly the central processing unit 30 calculates, during operation (e.g., periodically at a regular time interval), a new load plan on the basis of subscribed powers (and the associated changes) and real consumption actually measured and a predetermined distribution algorithm taking into consideration the performance curves of each of the sources A, B, C and D.

This new load plan then makes it possible to adjust the nominal allocation of said power sources to each of the server racks maximizing efficiency.

More particularly, the allocation algorithm has the yield curve of each of the sources on the basis of the load thereof. Note here that yield curves are not necessarily identical between all sources.

The algorithm also has powers subscribed to by each subscriber for each bay and the consumption measured for each bay (and thus consequently overall consumption).

Optionally, the overall consumption may be a specific measure. In this case, it becomes possible to perform the calculation of the difference between the amount of power consumed and the specific measure of total consumption. This may allow monitoring of any latent failures or other faults.

The method of allocating different sources can be done in different ways.

For example, the selected allocation algorithm may be as follows.
at first, a calculation of the ideal load of each source on the basis of criteria defined by the site manager (with the goal of balancing the sources together, or else to place them at peak efficiency points, or other). This step is to divide macroscopically the total load of the site.
in a second phase, a distribution of the racks one by one on the sources to supply same with power at the loads calculated in the first step. This step involves the microscopic distribution of the racks on the sources.

Obviously, this is one example of assignment among others.

In this example, the load plan can thus be updated in an automated manner on the basis of the actual consumption of the different racks.

Alternatively, one can also imagine an embodiment in which the adjustment is made so as to favour the life of the inverters.

This measured consumption also allows the FPGA of each switching element to apply safety rules and to interrupt the power source in case of abnormal consumption and thus not endanger the overall operation of the facility.

Consumption log files enable the central unit 30 (or 30′) to control two uses:
centralization of consumption for optimized customer billing; and
optimizing the overall system performance through continuous improvement of brewing sources.

It is also necessary to switch alternately from a source and/or from one phase to the other. This passage is difficult because it must be done in a single alternation and upon the passage to 0 of the latter. Moreover, it is important never to short circuit the phases amongst each other.

In this example, the switching elements are semiconductors of IGBT type and/or electronic components of the TRIAC-type. The selection of these switching elements (or SWE) is made on the basis of the model of the SWU box and the maximum current to be supplied.

As explained above, these switching elements are controlled by a FPGA circuit which ensures the conduction or non-conduction status of the IGBTs or TRIACs, and also provides control thereof.

Such a circuit also provides real-time protection of the facility.

Indeed, in the event of over-consumption or short-circuit the power supply, the FPGA makes it possible to cut the power source in just a few nanoseconds, ensuring the proper functioning of the site as a whole with a cascade effect being impossible.

Considering the status of the power sources is also one of the other objectives of the present invention.

A power source can be considered to be in failure status when it is outside the expected characteristics, for example when it delivers a voltage outside a range corresponding here to a predetermined template.

Outside this range, the expected quality of service is not guaranteed, which can corrupt the stored data.

The criterion of validity of a source is on the basis of the different phases belonging to templates.

Compliance with these templates also makes it possible to monitor the temporal conformity of the electrical phases.

In the context of the present invention a monitoring module 40 (or 40′) is envisaged which continually monitors at a step S1 the status of each of the power sources A, B, C and D for detecting any failure of at least one of the power sources A, B, C and D.

Not only must the failure of at least one of the sources be detected, but it is also desirable to know which is the failed source, and, if necessary, how many sources have failed. So, the source failures must be located.

This information is then transmitted to the central unit 30 (or 30′), but also to all the switching elements and this is in real time.

It is thus clear that here the central processing unit 30 (or 30′) determines the load plan on the basis of both subscribed power, the consumption of the measured server racks and the statuses of the sources A, B, C and D.

The central processing unit 30 (or 30′) will also be able to formulate an adapted decision upon detection of over-consumption by a server rack.

For example, there can be an interruption S2′ of SWE output supplying a rack in the event of detection of an abnormal consumption of said rack (e.g., strictly greater than 150% of the maximum subscribed power thereof).

The dynamic switching therefore takes into consideration both the actual consumption of each of the server racks and the status of each of the power sources, making it possible to significantly improve energy efficiency in the datacenter.

Through this dynamic switching, it is thus possible to have a system for selecting, at any moment, what power source supplies which server rack.

Such switching therefore makes it possible to significantly increase server availability.

This also ensures phase load balancing within each energy source in real time.

It is also possible to load the sources differently from one another to place them individually at points of optimum yields.

We further know that a one three-phase source performs better if its phases are balanced (equivalent consumption on the different phases).

Since the SWU boxes being of several types on the basis of the server technologies used, in the context of the present invention, it is envisaged to have the boxes 10 and 20 providing single-phase, three-phase and four-phase in one switch panel 100.

The objective of this phase of optimization is to distribute the different loads on the sources in order to optimize the performance of the inverters by placing them at their maximum performance and also by balancing as much as possible the phases of each source.

The dynamic power switching makes this optimization possible in response to the evolution of the consumption of the racks.

The performance is no longer limited and imposed by the original wiring. Nominal assignments can then be updated on the basis of the instantaneous consumption of the racks.

Thus, in the context of the present invention, we have a system 200 capable of managing multiple power sources A, B, C and D dynamically.

By means of the dynamic switching of the racks on the sources, it is possible to reassign the corresponding socket to another available source.

The server racks thus keep their redundancy.

In this way, the availability of the servers that are now able to survive the failure of the power sources is increased.

We must of course ensure that the sizing of the sources is adapted to the number of servers: in fact, each power source alone must be able to supply all the servers.

It is also possible to have a finer grading in the distribution of electrical power due to the presence of a PDU (for “Power Distribution Unit”).

Such a module (not shown) makes it possible to manage service quality across the servers and not across the racks.

The system 200 according to the present invention therefore aims to monitor and direct the electrical traffic.

In principle, it is able to trace the power consumption of each server and each server rack. This avoids the costly installation of a dedicated metering system, and greatly facilitates the task of the operator of the datacenter.

Indeed, the entire power management is centralized on a single apparatus: the subscribed to and consumed power and consumption by periods of time.

The dynamic switching proposed as part of the present invention thus provides high energy efficiency. The ability to make use of a source via software configuration offers the ability to install these sources gradually and not upon commissioning of the datacenter.

For example, early in the life of a datacenter, it is common for it to be under-loaded, and does not justify all of its power sources.

Besides financial gain in terms of investment, it makes it possible especially to have apparatuses operating at sufficient rates to have good performance

The dynamic switching solution proposed in the context of the present invention thus has the following advantages:
upgrading the backup capacity of the site (increase of 50% of the capacity);
improved site energy efficiency (PUE optimization);
simplifying the tracking of subscribers' consumption;
elimination of the need for hands-on monitoring of “capacity planning”;
elimination of the need for regular switching of endpoints onto sources;
improving the overall reliability of energy distribution, allowing dynamic reallocation of servers connected to a faulty source to another functioning source.

It should be observed that this detailed description relates to a particular embodiment of the present invention, but in no case does this description limit the object of the invention; rather, it aims to remove any possible inaccuracy or misinterpretation of the following claims.

It should also be noted that reference signs in parentheses in the claims that follow do not show, in any way, any limitation; these signs are intended only to improve the intelligibility and understanding of the claims which follow as well as the scope of the protection sought.

1. A method for managing power of a plurality of apparatuses (BS1, BS2, BS3, BS4) in a facility (300), each of the apparatuses (BS1, BS2, BS3, BS4), which consume electric power, being electrically connected to a plurality of power sources (A, B, C, D) through at least one distribution device (100, 100′) comprising a central processing unit (30, 30′) and switching elements ({11, 12, 13, 14; 21, 22, 23, 24}, {11′, 12′, 13′, 14′; 21′, 22′, 23′, 24′}) interfacing between said apparatuses (BS1, BS2, BS3, BS4) and said power sources (A, B, C, D), each of the power sources (A, B, C, D) having a predetermined yield curve, said switching elements ({11, 12, 13, 14; 21, 22, 23, 24}, {11′, 12′, 13′, 14′; 21′, 22′, 23′, 24′}), operated real-time via control circuits ({15, 16, 17, 18; 25, 26, 27, 28}, {15′, 16′, 17′, 18′; 25′, 26′, 27′, 28′}) being configured to distribute, at the beginning of operation, the electrical energy required to operate said apparatuses (BS1, BS2, BS3, BS4) according to a predetermined nominal allocation, said method implemented by computer means comprising, during an operating phase (PI), the following steps:
determining (S3) a load plan for charging by said central unit (30, 30′) on the basis of at least one subscribed power for each of the apparatuses (BS1, BS2, BS3, BS4) and a distribution algorithm;
a dynamic stirring (S4) of said apparatuses (BS1, BS2, BS3, BS4) of the power sources (A, B, C, D) formed by said switching elements ({11, 12, 13, 14; 21, 22, 23, 24}, {11′, 12′, 13′, 14′; 21′, 22′, 23′, 24′}) on the basis of said load plan transmitted by said central unit (30, 30′) to each of the control circuits ({15, 16, 17, 18; 25, 26, 27, 28}, {15′, 16′, 17′, 18′; 25′, 26′, 27′, 28′}).

2. The method of claim 1 comprising a continuous measurement (S2) of the power consumption of each apparatus (BS1, BS2, BS3, BS4), and wherein the determination (S3) of said load plan by said central unit (100, 100′) is further performed on the basis of said measured consumption.

3. The method of claim 2, wherein the switching elements ({11, 12, 13, 14; 21, 22, 23, 24}, {11′, 12′, 13′, 14′; 21′, 22′, 23′, 24′}) measure the power consumption of each apparatus (BS1, BS2, BS3, BS4) that each respectively feeds by magnetically coupling.

4. A method according to claim 1, comprising continuously monitoring (S1) the status of each of the power sources (A, B, C, D) for detecting the failure of at least one of the supply sources (A, B, C, D), wherein the determination (S3) of said load plan by said central unit (100, 100′) is further performed on the basis of said statuses.

5. The method of claim 4, wherein, when monitoring (SI) the status of each of the power sources (A, B, C, D), a power source (A, B, C, D) is considered to be in a failure status when the latter delivers a voltage outside a range between a lower failure threshold and a higher failure threshold.

6. The method of claim 5, wherein the lower failure threshold and/or the upper failure threshold are configurable voltage values.

7. A method according to claim 1, wherein the determination (S3) of a load plan with said central unit (30, 30′) is carried out further on the basis of a predetermined allocation algorithm taking into consideration the performance curves of each of the sources (A, B, C, D) so as to adjust the nominal allocation of said power sources (A, B, C, D) to each of the apparatuses (BS1, BS2, BS3, BS4) while maximizing efficiency.

8. A method according to claim 1, comprising an initialisation phase (P0) at which the nominal load plan is determined in a designation step (S0) on the basis of an electric power subscribed to beforehand by a subscriber, said subscribed electric power being associated with a predetermined level of quality of service.

9. A method according to claim 1, comprising an interruption (S2′) of the power supply to an apparatus (BS1, BS2, BS3, BS4) by said associated source (A, B, C, D) upon detection of abnormal consumption by said apparatus, e.g., strictly greater than 150% of the subscribed power.

10. (canceled)

11. A non-transitory recording medium readable by a computer on which is recorded a computer program comprising instructions that when executed by the computer causes the computer to execute the steps of the method according to claim 1.

12. A management system (200) of the electrical supply of a plurality of apparatuses (BS1, BS2, BS3, BS4) in a facility (300)),
wherein each of the apparatuses (BS1, BS2, BS3, BS4), which consume electrical energy, is electrically connected to a plurality of power sources (A, B, C, D) through at least one distribution device (100, 100′),
wherein each of the power sources (A, B, C, D) has a specific yield curve, and
wherein said at least one distribution device (100, 100′) comprises switching elements ({11, 12, 13, 14; 21, 22, 23, 24}, {11′, 12′, 13′, 14′; 21′, 22′, 23′, 24′}), making the interface between said apparatus (BS1, BS2, BS3, BS4) and said power sources (A, B, C, D) configured to distribute, at the beginning of operation, the electrical energy required to operate the apparatuses (BS1, BS2, BS3, BS4) according to a predetermined nominal allocation,
wherein said at least one distribution device (100, 100′) comprises:
a central processing unit (30, 30′) configured to determine a charging scheme on the basis of at least one subscribed power for each of the apparatuses and a distribution algorithm;
control circuitry ({15, 16, 17, 18; 25, 26, 27, 28}, {15′, 16′, 17′, 18′; 25′, 26′, 27′, 28′}) configured to operate, in real time on the basis of said load plan transmitted by said central unit (30, 30′) said switching elements ({11, 12, 13, 14; 21, 22, 23, 24}, {11′, 12′, 13′, 14′; 21′, 22′, 23′, 24′}), so as to produce a dynamic switching of said apparatuses (BS1, BS2, BS3, BS4) on the supply sources (A, B, C, D).

13. A system (200) according to claim 12 comprising a computer means configured for the implementation of the method steps of a method for managing power of a plurality of apparatuses (BS1, BS2, BS3, BS4) in a facility (300), each of the apparatuses (BS1, BS2, BS3, BS4), which consume electric power, being electrically connected to a plurality of power sources (A, B, C, D) through at least one distribution device (100, 100′) comprising a central processing unit (30, 30′) and switching elements ({11, 12, 13, 14; 21, 22, 23, 24}, {11′, 12′, 13′, 14′; 21′, 22′, 23′, 24′}) interfacing between said apparatuses (BS1, BS2, BS3, BS4) and said power sources (A, B, C, D),
each of the power sources (A, B, C, D) having a predetermined yield curve,
said switching elements ({11, 12, 13, 14; 21, 22, 23, 24}, {11′, 12′, 13′, 14′; 21′, 22′, 23′, 24′}), operated real-time via control circuits ({15, 16, 17, 18; 25, 26, 27, 28}, {15′, 16′, 17′, 18′; 25′, 26′, 27′, 28′}) being configured to distribute, at the beginning of operation, the electrical energy required to operate said apparatuses (BS1, BS2, BS3, BS4) according to a predetermined nominal allocation,
said method implemented by computer means comprising, during an operating phase (PI), the following steps:
determining (S3) a load plan for charging by said central unit (30, 30′) on the basis of at least one subscribed power for each of the apparatuses (BS1, BS2, BS3, BS4) and a distribution algorithm;
a dynamic stirring (S4) of said apparatuses (BS1, BS2, BS3, BS4) of the power sources (A, B, C, D) formed by said switching elements ({11, 12, 13, 14; 21, 22, 23, 24}, {11′, 12′, 13′, 14′; 21′, 22′, 23′, 24′}) on the basis of said load plan transmitted by said central unit (30, 30′) to each of the control circuits ({15, 16, 17, 18; 25, 26, 27, 28}, {15′, 16′, 17′, 18′; 25′, 26′, 27′, 28′}),
and wherein the determination (S3) of said load plan by said central unit (100, 100′) is further performed on the basis of said measured consumption.

14. A system (200) according to claim 12, wherein the switching elements ({11, 12, 13, 14; 21, 22, 23, 24}, {11′, 12′, 13′, 14′; 21′, 22′, 23′, 24′}) comprise a semiconductor of the IGBT type and/or an electronic component of the TRIAC-type.

15. A system (200) according to claim 12, wherein said at least one distribution device (100, 100′) is configured to deliver respectively single-phase, three-phase and/or four-phase.

16. A data processing center type facility (300), or datacenter, comprising:
a plurality of electric power sources (A, B, C, D);
a plurality of a server rack type computer apparatuses (BS1, BS2, BS3, BS4); and
A system (200) of the power management according to claim 1.

17. A system (200) according to claim 13, wherein the switching elements ({11, 12, 13, 14; 21, 22, 23, 24}, {11′, 12′, 13′, 14′; 21′, 22′, 23′, 24′}) comprise a IGBT semiconductor and/or a TRIAC electronic component.

18. The method according to claim 2, further comprising continuously monitoring (S1) the status of each of the power sources (A, B, C, D) for detecting the failure of at least one of the supply sources (A, B, C, D), wherein the determination (S3) of said load plan by said central unit (100, 100′) is further performed on the basis of said statuses,
wherein, when monitoring (SI) the status of each of the power sources (A, B, C, D), a power source (A, B, C, D) is considered to be in a failure status when the latter delivers a voltage outside a range between a lower failure threshold and a higher failure threshold, and
wherein the lower failure threshold and/or the upper failure threshold are configurable voltage values.

19. A method according to claim 2, wherein the determination (S3) of a load plan with said central unit (30, 30′) is carried out further on the basis of a predetermined allocation algorithm taking into consideration the performance curves of each of the sources (A, B, C, D) so as to adjust the nominal allocation of said power sources (A, B, C, D) to each of the apparatuses (BS1, BS2, BS3, BS4) while maximizing efficiency.

20. A method according to claim 18, wherein the determination (S3) of a load plan with said central unit (30, 30′) is carried out further on the basis of a predetermined allocation algorithm taking into consideration the performance curves of each of the sources (A, B, C, D) so as to adjust the nominal allocation of said power sources (A, B, C, D) to each of the apparatuses (BS1, BS2, BS3, BS4) while maximizing efficiency.
